(19) United States
(12) Patent Application Publication
(10) Pub. No.: US 2023/0087705 A1
(43) Pub. Date: Mar. 23, 2023

(54) INTEGRATED STANDBY POWER SUPPLY

(71) Applicant: Apple Inc., Cupertino, CA (US)

(72) Inventors: Chanwit Prasantanakorn, Santa Clara, CA (US); Bharat K Patel, San Martin, CA (US)

(21) Appl. No.: 17/655,644

(22) Filed: Mar. 21, 2022

Related U.S. Application Data
(60) Provisional application No. 63/261,434, filed on Sep. 21, 2021.

(51) Int. Cl. H02M 1/00; H02M 3/00; H02M 3/24; G06F 1/26

(52) U.S. Cl. CPC H02M 1/0032; H02M 3/01; H02M 3/24; G06F 1/26

(57) ABSTRACT

A power supply can include a main power converter, a standby converter, and control circuitry that operates the standby converter in a constant voltage regulation mode when a load current of the power supply is below a standby threshold and operates the standby converter in a constant current regulation mode when the load current of the power supply is above the standby threshold. The control circuitry can operate the standby converter in a constant voltage regulation mode to produce a voltage higher than a regulated output voltage of the main power converter. The control circuitry can idle the main power converter when a load current of the power supply is below the standby threshold. The standby threshold can correspond to a constant current limit of a constant current control loop of the standby converter. The control circuitry can employ hysteresis to the standby threshold/constant current control loop.

### CROSS-REFERENCE TO RELATED APPLICATIONS

This application claims priority to U.S. Provisional Application No. 63/261,434, filed Sep. 21, 2021, entitled “INTEGRATED STANDBY POWER SUPPLY,” which is hereby incorporated by reference in its entirety.

### BACKGROUND

Power supplies such as those used with desktop computers or other systems typically employ two power converters that drive separate power outputs. A first “main” converter operates to power the system via a main power output when the system is running. A second “standby” converter operates to power the system via a standby power output when the system is in standby mode. The main converter may be designed to have peak efficiency at a relatively high load level, while the standby converter ay be designed to have peak efficiency at a relatively low load level below a level that can power the running system. Traditionally, control logic in the powered system determines whether the system is in the running mode or the standby mode, and sends control signals to the power supply to command operation of one or the other converter as appropriate.

### SUMMARY

In some embodiments it may be desirable to provide a single output power supply that is nonetheless capable of operating with high efficiency both in a normal operating mode and in a standby mode. Exemplary arrangements to achieve these objectives are described herein.

A power supply can include a main power converter, a standby converter, and control circuitry that operates the standby converter in a constant voltage regulation mode when a load current of the power supply is below a standby threshold and operates the standby converter in a constant current regulation mode when the load current of the power supply is above the standby threshold. The control circuitry can include a control loop of the standby converter. The control circuitry can operate the standby converter in a constant voltage regulation mode to produce a voltage higher than a regulated output voltage of the main power converter. The control circuitry can idle the main power converter when a load current of the power supply is below the standby threshold. The control circuitry can idle the main power converter by disabling switching of the main power converter. The standby threshold can be 10% of a rated power of the power supply. The standby threshold can correspond to a constant current limit of a constant current control loop of the standby converter. The control circuitry can employ hysteresis to the standby threshold/constant current control loop such that as the load current of the power supply increases toward the standby threshold a higher constant current limit is used and as the load current of the power supply decreases toward the standby threshold a lower constant current limit is used. The standby converter can be a flyback converter. The main converter can be a resonant LLC converter.

A method of operating a power supply with integrated standby power having a standby converter and a main converter can include comparing a load current of the power supply to a standby threshold and, responsive to a load current below the standby threshold, operating the standby converter in a constant voltage regulation mode and idling the main converter; or, responsive to a load current above the standby threshold, operating the standby converter in a constant current regulation mode and operating the main converter in a constant voltage regulation mode. The method can be performed at least in part by a control loop of the standby converter.

Operating the standby converter in a constant voltage regulation mode can produce a voltage higher than a regulated output voltage of the main power converter. Idling the main power converter can include disabling switching of the main power converter. The standby threshold can be 10% of a rated power of the power supply. The standby threshold can correspond to a constant current limit of a constant current control loop of the standby converter. The method can further include applying hysteresis to the standby threshold such that as the load current of the power supply increases toward the standby threshold a higher constant current limit is used and as the load current of the power supply decreases toward the standby threshold a lower constant current limit is used. The standby converter can be a flyback converter. The main converter can be a resonant LLC converter.

A computer system can include a logic board and a power supply as described above.

### BRIEF DESCRIPTION OF THE DRAWINGS

FIG. 1 illustrates an exemplary prior art arrangement including a dual output power supply and a main logic board of a personal computer.

FIG. 2 illustrates exemplary efficiency curves of a main converter and a standby converter of a conventional power supply.

FIG. 3 illustrates output voltages of a conventional power supply and the control signals used to select between the standby and main outputs.

FIG. 4 illustrates a single output power supply with integrated standby power.

FIG. 5 illustrates output voltages of a single output power supply with integrated standby power.

FIG. 6 illustrates various operating regimes of a single output power supply with integrated standby power.

FIG. 7 illustrates an efficiency curve of a single output power supply with integrated standby power.

FIG. 8 illustrates an exemplary constant current limit hysteresis curve that may be used with a single output power supply with integrated standby power.

FIG. 9 illustrates flow charts of operating techniques of a single output power supply with integrated standby power.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

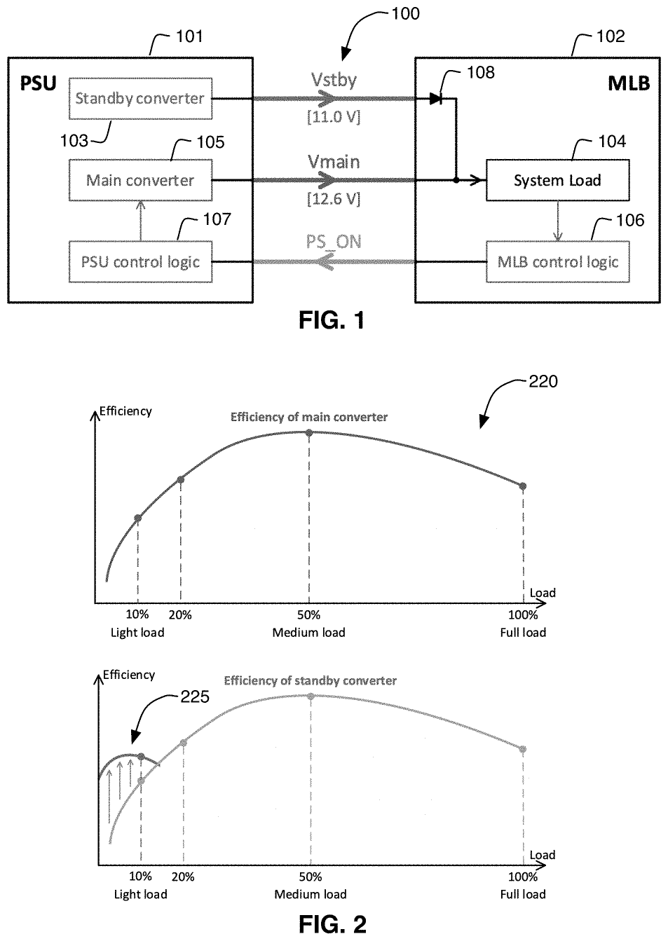

FIG. 1 illustrates a typical prior art power supply arrangement 100 for a desktop computer. Although the following discussion describes a desktop computer embodiment, the teachings herein are applicable to any system that exhibits a low power mode or condition, referred to herein as a standby mode or condition, and a higher power mode or condition, referred to herein as an operating mode or condition. Power supply 101 can have two power outputs that are coupled to a main logic board 102. One power output can be driven by a standby converter 103 to power system load 104 in a standby condition, for example when a desktop computer is in a sleep state. A second power output can be driven by a main converter 105 to power system load 104 in an operating condition, for example when a desktop computer is in use. Control logic 106 can monitor system load 104 to determine the amount of power required. If a higher amount of power is required, such as when the system is in the normal operating mode, a control signal PS_ON can be sent to power supply control logic 107 to cause the main converter to operate, suppling a voltage Vmain to the system load via the main output. Alternatively, if a lower amount of power is required, such as when the system is in a standby mode, the control signal PS_ON may be de-asserted, causing power supply control logic 107 to disable the main converter and instead allow the constantly operating standby converter 103 to power the load.

Main converter 105 may be configured to provide a slightly higher regulated output voltage (e.g., 12.6V), while standby converter 103 can be configured to provide a slightly lower regulated output voltage (e.g., 11.0V). As a result, diode 108 on main logic board 102 can serve as a selector between the two outputs of power supply 101. More specifically, when main converter 105 is not operating, diode 108 will be forward biased, allowing system load 104 to be powered by the constantly operating standby converter 103. Conversely, when main converter 105 is operating, diode 108 will be reversed biased, and system load 104 will be powered by main converter 105.

The reasons for this arrangement relate to operating efficiency. FIG. 2 illustrates exemplary efficiency curves. Efficiency curve 220 depicts the efficiency of a typical main converter 105 versus operating load. The exact shape of efficiency curve 220 will depend on the particular converter type, design, and construction, but it is fairly typical for switching power converters to exhibit relatively low efficiency in light load conditions (e.g., 10-20% of rated load), peak efficiency at a moderate or medium load (e.g., 50% of rated load), with decreasing efficiency as full load is approached. Thus, a power supply rated to power a system such as personal computer at full load may be close to its peak efficiency in “normal” load conditions less than full load, but may be quite inefficient in low load conditions, such as when the system is in a standby mode. This is why the second standby converter is provided. The standby converter may be designed with sufficient capacity to power the system in the low power or standby mode while operating at a higher efficiency level than the main converter would have in such conditions. This allows for relatively higher efficiency in these light load regimes.

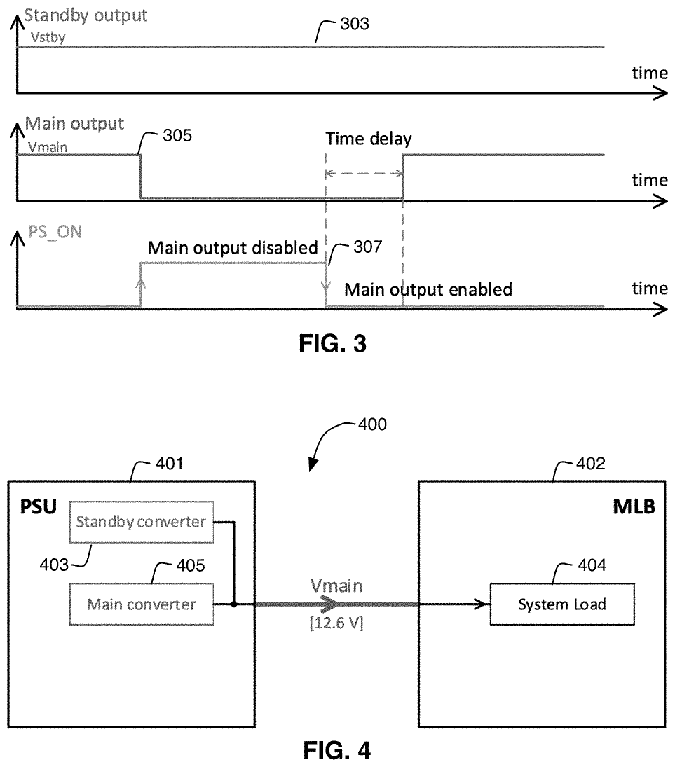

As mentioned above, control logic 106, which may be located on main logic board 102 can detect whether the system load 104 corresponds to a standby mode or an operating mode and can provide control signal PS_ON to power supply control logic 107 to activate/deactivate main converter 105 accordingly. FIG. 3 illustrates the respective output voltages and power supply control signals. As illustrated in FIG. 3, the standby output voltage 303 is on constantly because standby converter 103 operates continuously. Main output voltage 305 is present when the main output is enabled (corresponding to a low PS_ON signal 307) and is not present when the main output is disabled (corresponding to a high PS_ON signal 307). This enable/disable functionality is controlled by control logic 106/107. Also, a high/enable-low/disable signal could also be used. Also illustrated in FIG. 3 is a time delay that may occur between the time the PS_ON signal to activate main power supply 105 is sent/received and the time main power supply 105 begins supplying output voltage Vmain. This delay also means that there is a corresponding delay in the system being able to transition from the standby mode to the operating mode.

Thus, for some applications it may be desirable to provide a power supply that integrates the standby power converter and main converter in such a way that only a single power output to the logic board is required and the control signals between the logic board and power supply may be eliminated. Such an arrangement 400 is illustrated in FIG. 4. Power supply 401 can include a standby converter 403 and a main converter 405 with their respective outputs coupled in parallel and provided to a single output of power supply 401. Standby converter 403 may employ any suitable topology. In some embodiments, standby converter 403 may be a flyback converter, which typically exhibit high efficiency at low loads. The standby converter may be designed to provide a power level that is about 10% of the full load power of the power supply, although this could range from 5% or even less to 15%, 20%, or even more if appropriate for a given application. Power supply 401 can also include a main converter 405. Main converter 405 may be constructed using any suitable topology. In some embodiments, main converter 405 may be an LLC resonant converter, which typically exhibits high efficiency at higher loads. Main converter 405 can be designed to provide 100% of the full load power required by the system. Control schemes for standby converter 403 and main converter 405 are described in greater detail below. Power supply 401 can provide a single power output to logic board 402, which can include system load 404. It should be appreciated that logic board 402 may also distribute power to other loads that need not be present on logic board 402 itself.

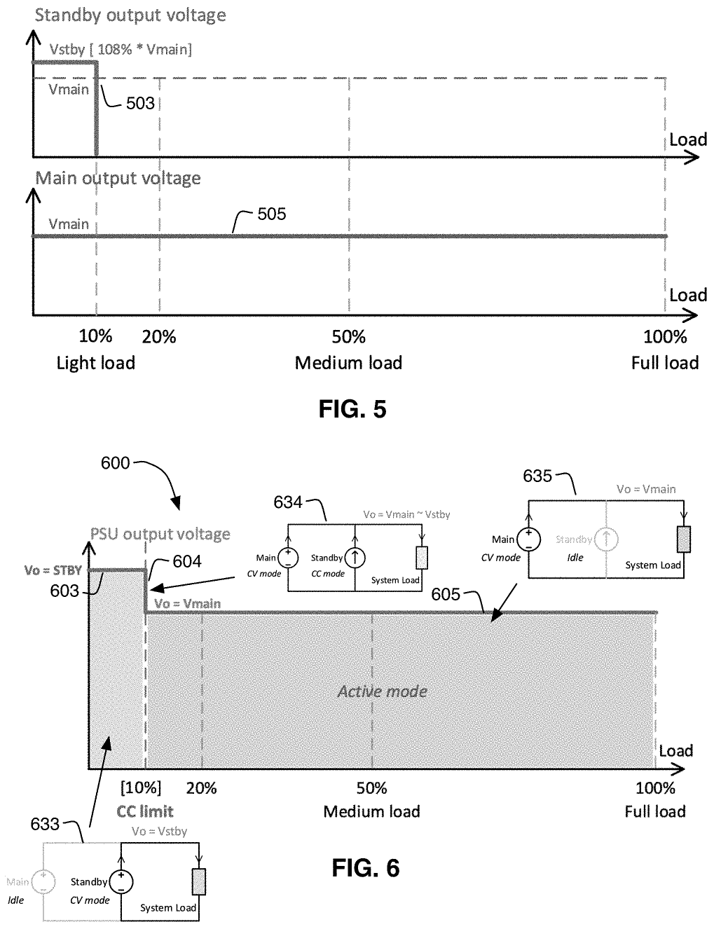

FIG. 5 illustrates one example configuration of the standby output voltage 503 of standby converter 403 and the output voltage 505 of main converter 405 as a function of load on the converter. Main converter 405 may be sized to provide 100% of the full load power of the system and may be operated using a constant voltage control technique, such that the main output voltage 505 of the main converter is regulated to a constant value Vmain. Standby converter 403 may be sized to provide a predetermined fraction of the rated output power of the system. For example, standby converter 503 may be designed to provide 10% of the rated output power of the system, although, as noted above, this “standby threshold” can vary.

For loads below the standby threshold, standby power supply 403 may be configured to operate in a constant voltage control mode. In constant voltage control mode switching devices of the converter may be operated to regulate the output voltage 503 of standby converter 403 (i.e., standby converter output voltage 503) to a value that is slightly greater than the output voltage of the main converter. For example, standby converter may be configured to provide a standby output voltage that is 108% of the main output voltage. Other percentages may also be used as appropriate for a given embodiment. As a result, for loads below the standby threshold, power will be supplied from standby converter 403 and not from main converter 505 because of the higher output voltage of standby converter 403.

For loads at (and optionally above) the standby threshold, standby converter 403 may be configured to operate in a constant current control mode. In constant current control mode switching devices of standby converter 403 may be operated to regulate the output current of standby converter 403 to a value that corresponds to the standby threshold power level (e.g., 10% of the converter's rated output). As a result, as the load increases and reaches the standby threshold the output voltage of standby converter 403 will decrease until it falls below Vmain (the output voltage 505 of constant voltage regulated main converter 405). At that point, power will be drawn from main converter 505. Standby converter 403 may either be idled/disabled at this point, or it can be configured to continue to supply the constant current limit corresponding to the standby threshold. The former may be preferred for some applications, as it may result in a higher overall system efficiency. In either case, once the load reaches the standby threshold, the parallel connection of standby converter 403 and main converter 405, together with the transition from constant voltage to constant current control of standby converter 403 result in a seamless transition from standby power to normal power without the delay discussed above.

FIG. 6 further illustrates the various operating regimes of power supply 401. For loads greater than the standby threshold (e.g., 10% of the rated output power), power supply 401 operates in the active mode, represented by simplified schematic 635. In the active mode, main converter 405 operates in a constant voltage mode to produce an output voltage 605 equal to Vmain that is supplied to the system load. Standby converter 403 may be idle in this mode. For loads less than the standby threshold (e.g., 10% of the rated output power), power supply 401 operates in the standby mode, represented by simplified schematic 633. In the standby mode, standby converter 403 is operated in a constant voltage mode to produce an output Vstby/603 that is slightly greater than the regulated output voltage Vmain of main converter 405. Main converter 405 is thus effectively idle in this mode, because its constant voltage regulated output Vmain is less than the constant voltage regulated output Vstby produced by standby converter 403.

At the standby threshold, both standby converter 403 and main converter 405 may be active, as depicted in simplified schematic 634. More specifically, main converter 405 may operate in a constant voltage control mode, producing an output voltage Vmain. Contemporaneously therewith, standby converter 403 may be operated in a constant current mode as described above. At this point in the transition between standby mode and active mode, power supply loading will transition between standby converter 403 and main converter 405, with a corresponding voltage transition 604 from the standby voltage Vstby/603 to the main voltage Vmain/605.

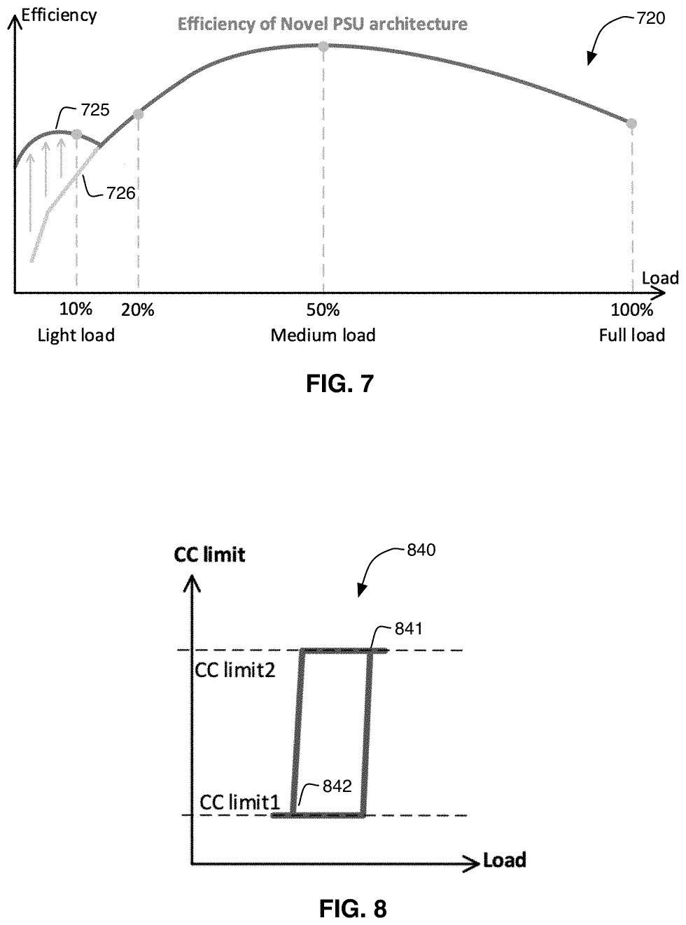

FIG. 7 illustrates an exemplary efficiency curve 720 of an integrated standby power supply as described above. In light load conditions, the power supply follows curve segment 725, which corresponds to the efficiency of standby converter 403. In this operating regime, the efficiency can be significantly higher than curve segment 726, which corresponds to the efficiency that main converter 405 would have at the same load level. Otherwise, at higher load levels, efficiency curve corresponds to the efficiency of main converter 405. It should also be noted that FIG. 7 depicts a standby threshold of greater than 10%, meaning that the transition from standby converter 403 to main converter 405 takes place at a slightly higher load level (just below 15% in the illustrated example). Notwithstanding, the basic principles illustrated in FIG. 7 are applicable to a variety of standby thresholds and converter efficiency profiles.

In some applications it may be desirable to provide a hysteresis function for the current limit used for standby converter 403 when in the constant current mode. FIG. 8 illustrates an exemplary hysteresis curve for such applications. Beginning in the lower left quadrant of FIG. 8, at low load conditions, a relatively higher constant current limit CClimit2 may be employed. As the load on the power supply increases it will eventually reach CClimit2 at point 841. This is the point at which the current of standby converter 403 will be limited, and main converter 405 will begin powering the load. For further load increases, standby converter 403 will carry more and more of the load, and standby converter 405 can either be idled or can continue to provide a fraction of the power as appropriate for a given application. Additionally, once an increasing load triggers a transition of standby converter 403 from the constant voltage mode to the constant current mode, the constant current limit of standby converter 405 may be decreased to a relatively lower constant current limit CClimit1. Thus, as the load decreases, main converter 405 will continue providing power until the current drops below CClimit1 (842), at which point standby converter 403 will transition from constant current regulation back to constant voltage regulation.

This hysteresis effectively provides a guard band around the transition between operating modes of the standby converter that can improve overall system function and stability. The hysteresis may employ varying degrees of difference between the two limits. In one example, the upper limit (CClimit2) may be a nominal standby threshold of 10% plus a hysteresis of 2.5% corresponding to a current limit that is 12.5% of the rated current of power supply 401. Similarly, the lower current limit (CClimit1) may be the nominal standby threshold of 10% minus a hysteresis of 2.5% corresponding to a current limit that is 7.5% of the rated current of power supply 401. These numerical values are only exemplary, and other values could be employed as appropriate for a given application.

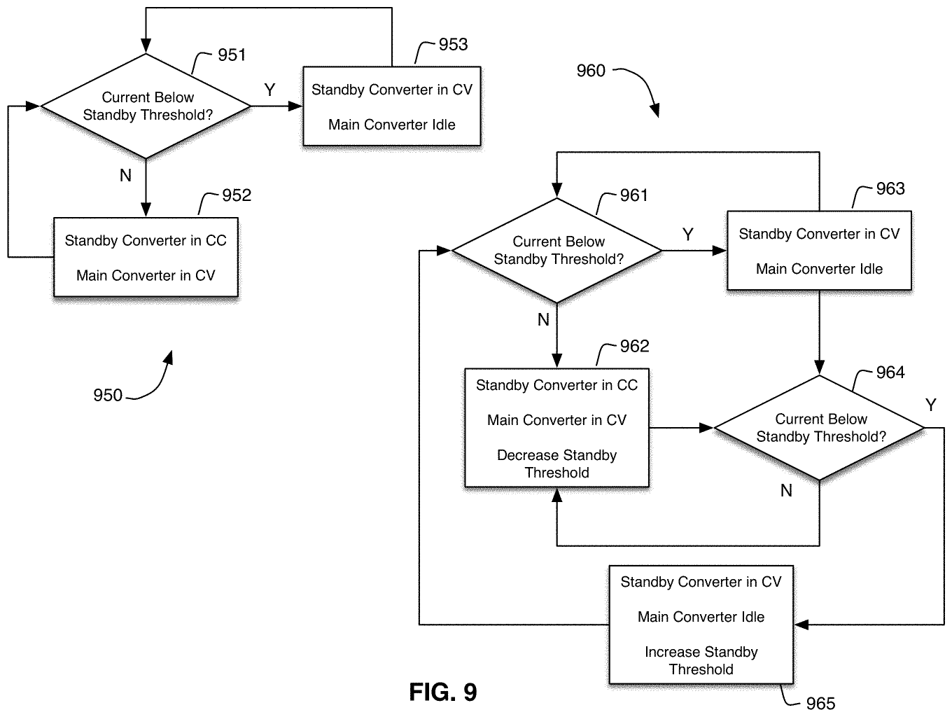

FIG. 9 illustrates flow charts depicting operation of a single output power supply with integrated standby power. Flowchart 950 illustrates operation without the hysteresis described above with respect to FIG. 8. Flowchart 960 illustrates operation with hysteresis as described in FIG. 8. Turning to flowchart 950 and beginning at block 951, control circuitry of the power supply, e.g., the control loop of standby converter 403, can determine whether the power supply current is below the standby threshold. If so (block 953) the standby converter may operate in a constant voltage regulation mode, and main converter 405 may be idle. As noted above this idle mode of main converter 405 can be “operating” but with no load because the constant voltage regulation mode of standby converter 403 regulates to a higher output voltage than the regulated output voltage of main converter 405. Alternatively, in some embodiments, control circuitry of the power supply, e.g., the control loop of main converter 405 can disable switching of the main power supply when the current is below the standby threshold (or below the standby threshold by more than a predetermined amount to ensure that there is no delay in starting switching of main converter 405 as the load increases above the standby threshold). Otherwise, if in block 951 the load current is above the standby threshold, then the control loop of standby converter 403 may transition to a constant current regulation mode, and the main converter may operate in a constant voltage regulation mode (block 952) as described above. In either case, the control circuitry can continue to monitor the load current with respect to the standby threshold (block 951) and transition the standby converter between constant voltage regulation mode and constant current regulation mode as appropriate.

Flowchart 960 expand the control flow of flowchart 950 to include a current limit hysteresis function as described with respect to FIG. 8. Beginning at block 961, control circuitry of the power supply, e.g., the control loop of standby converter 403, can determine whether the power supply current is below the standby threshold. If so (block 963) the standby converter may operate in a constant voltage regulation mode, and main converter 405 may be idle. As noted above this idle mode of main converter 405 can be “operating” but with no load because the constant voltage regulation mode of standby converter 403 regulates to a higher output voltage than the regulated output voltage of main converter 405. Alternatively, in some embodiments, control circuitry of the power supply, e.g., the control loop of main converter 405 can disable switching of the main power supply when the current is below the standby threshold (or below the standby threshold by more than a predetermined amount to ensure that there is no delay in starting switching of main converter 405 as the load increases above the standby threshold).

Otherwise, if in block 961 the load current is above the standby threshold, then the control loop of standby converter 403 may transition to a constant current regulation mode, and the main converter may operate in a constant voltage regulation mode (block 962) as described above. Additionally in block 962, the standby threshold may be decreased to a lower current limit as described above with respect to FIG. 8. Then, in block 964, the control circuitry may monitor whether the load current is below the (now lower) standby threshold. If not, the system may continue with standby converter 403 in constant current regulation mode and main converter in constant voltage regulation mode (block 962). It should be noted that the standby threshold is decreased only on initial entry to this mode (from block 961) and not when flow returns to block 962 from block 964. Otherwise, if in block 964 the current is below the lowered standby threshold, the standby converter can return to constant voltage regulation mode, the main converter may be idled (according to either of the techniques described above), and the standby threshold may be increased to its higher initial value (block 965), with flow returning to block 961. The control circuitry can then continue to monitor the load current with respect to the standby threshold (block 961) and transition the standby converter between constant voltage regulation mode and constant current regulation mode as appropriate.

The foregoing describes exemplary embodiments of power supplies with integrated standby power. Such systems may be used in a variety of applications but may be particularly advantageous when used as power supplies for intermittently operated electrical equipment or other equipment that alternates between a low power consumption standby mode and a higher power consumption normal operating mode. One example of such equipment can include desktop computers, but many other applications are also possible. Although numerous specific features and various embodiments have been described, it is to be understood that, unless otherwise noted as being mutually exclusive, the various features and embodiments may be combined in various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

Additionally, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A power supply comprising:
a main power converter;
a standby converter; and
control circuitry that operates the standby converter in a constant voltage regulation mode when a load current of the power supply is below a standby threshold and operates the standby converter in a constant current regulation mode when the load current of the power supply is above the standby threshold.

2. The power supply of claim 1 wherein the control circuitry includes a control loop of the standby converter.

3. The power supply of claim 1 wherein the control circuitry operates the standby converter in the constant voltage regulation mode to produce a voltage higher than a regulated output voltage of the main power converter.

4. The power supply of claim 1 wherein the control circuitry idles the main power converter when the load current of the power supply is below the standby threshold.

5. The power supply of claim 4 wherein the control circuitry idles the main power converter by disabling switching of the main power converter.

6. The power supply of claim 1 wherein the standby threshold is 10% of a rated power of the power supply.

7. The power supply of claim 1 wherein the standby threshold corresponds to a constant current limit of a constant current control loop of the standby converter.

8. The power supply of claim 7 wherein the control circuitry employs hysteresis to the standby threshold/constant current control loop such that as the load current of the power supply increases toward the standby threshold a higher constant current limit is used and as the load current of the power supply decreases toward the standby threshold a lower constant current limit is used.

9. The power supply of claim 1 wherein the standby converter is a flyback converter.

10. The power supply of claim 1 wherein the main power converter is a resonant LLC converter.

11. A method of operating a power supply with integrated standby power having a standby converter and a main converter, the method comprising:
comparing a load current of the power supply to a standby threshold; and
responsive to a load current below the standby threshold, operating the standby converter in a constant voltage regulation mode and idling the main converter; or
responsive to a load current above the standby threshold, operating the standby converter in a constant current regulation mode and operating the main converter in a constant voltage regulation mode.

12. The method of claim 11 wherein the method is performed at least in part by a control loop of the standby converter.

13. The method of claim 11 wherein operating the standby converter in the constant voltage regulation mode produces a voltage higher than a regulated output voltage of the main converter.

14. The method of claim 11 wherein idling the main converter comprises disabling switching of the main converter.

15. The method of claim 11 wherein the standby threshold is 10% of a rated power of the power supply.

16. The method of claim 11 wherein the standby threshold corresponds to a constant current limit of a constant current control loop of the standby converter.

17. The method of claim 16 further comprising applying hysteresis to the standby threshold such that as the load current of the power supply increases toward the standby threshold a higher constant current limit is used and as the load current of the power supply decreases toward the standby threshold a lower constant current limit is used.

18. The method of claim 11 wherein the standby converter is a flyback converter.

19. The method of claim 11 wherein the main converter is a resonant LLC converter.

20. A computer system comprising a logic board and a power supply according to claim 1.
